(19) United States
(12) Patent Application Publication
(10) Pub. No.: US 2023/0236795 A1
(43) Pub. Date: Jul. 27, 2023

(54) DATA PROCESSING METHOD IMPLEMENTED AT EDGE SWITCH, ELECTRONIC DEVICE, AND PROGRAM PRODUCT

(71) Applicant: Dell Products L.P., Round Rock, TX (US)

(72) Inventors: Chenxi Hu, Beijing (CN); Sanping Li, Beijing (CN); Zhen Jia, Shanghai (CN)

(21) Appl. No.: 17/678,270

(22) Filed: Feb. 23, 2022

(30) Foreign Application Priority Data
Jan. 21, 2022 (CN) 202210071619.6

(51) Int. Cl. G06F 7/491; G06N 20/00

(52) U.S. Cl. CPC G06F 7/4912; G06F 7/4917; G06N 20/00

(57) ABSTRACT

Embodiments of the present disclosure provide a data processing method implemented at an edge switch, an electronic device, and a program product. For example, a data processing method implemented at an edge switch is provided. The method includes receiving at least two data packets for floating-point arithmetic operations from at least one source device. In addition, the method may include acquiring corresponding floating-point numerical sequences respectively from the at least two data packets; and acquiring a floating-point arithmetic method from at least one data packet of the at least two data packets to determine a floating-point arithmetic result of the corresponding floating-point numerical sequences. The method may further include sending the floating-point arithmetic result to a target device indicated by the at least one data packet of the at least two data packets.

### RELATED APPLICATION(S)

The present application claims priority to Chinese Patent Application No. 202210071619.6, filed Jan. 21, 2022, and entitled “Data Processing Method Implemented at Edge Switch, Electronic Device, and Program Product,” which is incorporated by reference herein in its entirety.

### FIELD

Embodiments of the present disclosure relate to the field of Internet of Things (IoT), and more specifically, to a data processing method implemented at an edge switch, an electronic device, and a computer program product.

### BACKGROUND

With the development of Internet of Things (IoT) techniques, more and more IoT devices are widely applied. Some IoT devices, such as air conditioners, smart locks, traffic lights, and web cameras, can communicate with clouds or servers through edge switches communicatively connected thereto. It should be understood that data acquired from IoT devices, especially sensory data, can be used for machine learning or deep learning, or for some special applications, such as commercial applications. However, machine learning, deep learning, or commercial applications often require floating-point arithmetic. Such applications are currently hindered by the fact that IoT devices generally do not have floating-point arithmetic capabilities.

### SUMMARY

Embodiments of the present disclosure provide a solution of implementing data processing at an edge switch.

In a first aspect of the present disclosure, a data processing method implemented at an edge switch is provided. The method includes receiving at least two data packets for floating-point arithmetic operations from at least one source device. In addition, the method may include acquiring corresponding floating-point numerical sequences respectively from the at least two data packets; and acquiring a floating-point arithmetic method from at least one data packet of the at least two data packets to determine a floating-point arithmetic result of the corresponding floating-point numerical sequences. The method may further include sending the floating-point arithmetic result to a target device indicated by the at least one data packet of the at least two data packets.

In a second aspect of the present disclosure, an electronic device is provided, which includes: a processor; and a memory coupled to the processor, where the memory has instructions stored therein, which, when executed by the processor, cause the electronic device to perform actions including: receiving at least two data packets for floating-point arithmetic operations from at least one source device; acquiring corresponding floating-point numerical sequences respectively from the at least two data packets; acquiring a floating-point arithmetic method from at least one data packet of the at least two data packets to determine a floating-point arithmetic result of the corresponding floating-point numerical sequences; and sending the floating-point arithmetic result to a target device indicated by the at least one data packet of the at least two data packets.

In a third aspect of the present disclosure, a computer program product is provided. The computer program product is tangibly stored on a non-transitory computer-readable medium and includes machine-executable instructions that, when executed by a machine, cause the machine to perform any steps of the method according to the first aspect.

This Summary is provided to introduce the selection of concepts in a simplified form, which will be further described in the Detailed Description below. The Summary is neither intended to identify key features or main features of the present disclosure, nor intended to limit the scope of the present disclosure.

### BRIEF DESCRIPTION OF THE DRAWINGS

By further description of example embodiments of the present disclosure, provided herein with reference to the accompanying drawings, the above and other objectives, features, and advantages of the present disclosure will become more apparent, where identical or similar reference numerals generally represent identical or similar components in the example embodiments of the present disclosure. In the accompanying drawings:

FIG. 1 is a schematic diagram of an example environment according to an embodiment of the present disclosure;

FIG. 2 is a flowchart of a process of implementing data processing at an edge switch according to an embodiment of the present disclosure;

FIG. 3 is a flowchart of a process of processing floating-point numerical sequences by using a programmable circuit component arranged in an edge switch according to an embodiment of the present disclosure;

FIG. 4 is a signaling diagram of a process of implementing data processing at an edge switch according to an embodiment of the present disclosure; and

FIG. 5 is a block diagram of an example device that can be used to implement embodiments of the present disclosure.

### DETAILED DESCRIPTION

Principles of the present disclosure will be described below with reference to several example embodiments illustrated in the accompanying drawings.

The term “include” used herein and variants thereof indicate open-ended inclusion, that is, “including but not limited to.” Unless otherwise stated, the term “or” means “and/or.” The term “based on” denotes “at least partially based on.” The terms “an example embodiment” and “an embodiment” indicate “a group of example embodiments.” The term “another embodiment” indicates “a group of additional embodiments.” The terms “first,” “second,” and the like may refer to different or identical objects. Other explicit and implicit definitions may also be included below.

As discussed above, currently, Internet of Things (IoT) devices at edge nodes and edge switches generally do not have floating-point arithmetic functions. In an IoT device at a transmitting side, an embedded central processing unit (CPU) usually does not have strong computing power. Therefore, algorithms that require floating-point arithmetic are difficult to implement inline. A conventional method for users to solve this problem is to first quantize a floating-point value into an integer at a server side, then send it to an edge switch for simple online integer calculation, and finally convert the result from an integer to a floating-point value on the server. Therefore, the conventional data floating-point arithmetic process of an IoT device limits highly efficient transmission of data. In addition, due to the quantization conversion process from floating-point values to integers and from integers to floating-point values, the calculation accuracy is difficult to ensure. Moreover, in a cloud or server at a receiving side, due to the limited computing resources of the cloud and the server, the above-mentioned arithmetic mechanism may sometimes become a computing burden. Therefore, a conventional process of data floating-point arithmetic in the cloud or server is relatively inefficient.

To at least partially solve the above defects, embodiments of the present disclosure provide a solution of implementing data floating-point arithmetic at an edge switch. The solution can transfer computing operations such as floating-point addition and floating-point subtraction from a server side to the edge switch. Correspondingly, the solution may utilize a programmable circuit of the edge switch to implement floating-point data reception, floating-point arithmetic, and transmission at the same time. Hence, the computing power of the edge switch can be used to implement floating-point arithmetic operations on data.

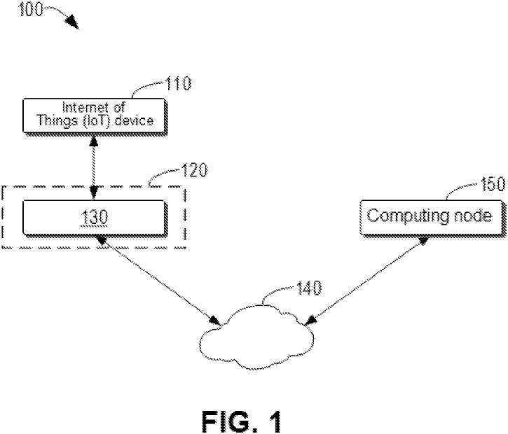

FIG. 1 is a schematic diagram of example environment 100 according to an embodiment of the present disclosure. In example environment 100, a device and/or a process according to an embodiment of the present disclosure may be implemented. As shown in FIG. 1, example environment 100 may include IoT device 110. IoT device 110 is generally an edge computing node that has limited computing power and is used to perform specific functions. As an example, IoT device 110 may be one or more air conditioners, smart locks, traffic lights, webcams, and the like.

In order to transmit data, IoT device 110 is usually communicatively connected to edge switch 120. Edge switch 120 is usually arranged near IoT device 110, which serves as an edge computing node, so as to provide a data exchange service for the corresponding IoT device. In order to undertake a calculation task of a data floating-point calculation operation of IoT device 110, computing device 130 arranged in edge switch 120 may perform a floating-point arithmetic operation on floating-point numerical sequences therein based on a data packet received from IoT device 110 for the floating-point arithmetic operation.

It should be understood that computing device 130 may be any device with computing power that is disposed in edge switch 120 or is communicatively connected to edge switch 120. As a non-limiting example, the computing device may be any type of fixed computing device, mobile computing device, or portable computing device, including but not limited to a desktop computer, a laptop computer, a notebook computer, a netbook computer, a tablet computer, a smart phone, and the like. All or part of the components of the computing device may be distributed in the cloud. The computing device may also adopt a cloud-edge architecture.

In addition, edge switch 120 may also include a storage apparatus (not shown). The storage apparatus includes a register for storing data. In addition, the storage apparatus may comprise one or more storage disks. The storage disk can be various types of devices with a storage function, including but not limited to a hard disk drive (HDD), a solid state drive (SSD), a removable disk, any other magnetic storage device, any other optical storage device, or any combination thereof. As an example, a data packet for floating-point arithmetic operations may be divided into multiple data blocks, and computing device 130 may perform floating-point arithmetic operations on these data blocks sequentially. Whenever a floating-point arithmetic operation is performed on a data block, the data block which has been subjected to the floating-point arithmetic can be stored in the storage apparatus. Moreover, when the floating-point arithmetic is completed for all the data blocks of the data packet, all the data blocks stored in the storage apparatus can be combined into a floating-point arithmetic result.

After performing the floating-point arithmetic operation on the data packet from IoT device 110, computing device 130 may send the data packet which has been subjected to the floating-point arithmetic to cloud (network) 140, and via the cloud 140, the data packet which has been subjected to the floating-point arithmetic can be sent to computing node 150. It should be understood that computing node 150 may be a server which has functions of training a machine learning model or a deep learning model. Hence, data communication from IoT device 110 to computing node 150 is implemented, and the entire data operation process of the communication is completed at the corresponding edge switch. Although not shown, the floating-point arithmetic result determined at edge switch 120 may also be returned to IoT device 110. That is, the floating-point arithmetic result may be output to any specified device.

It should be understood that the architecture and functions of example environment 100 are described for illustrative purposes only, without implying any limitation to the scope of the present disclosure. Embodiments of the present disclosure may also be applied to other environments having different structures and/or functions.

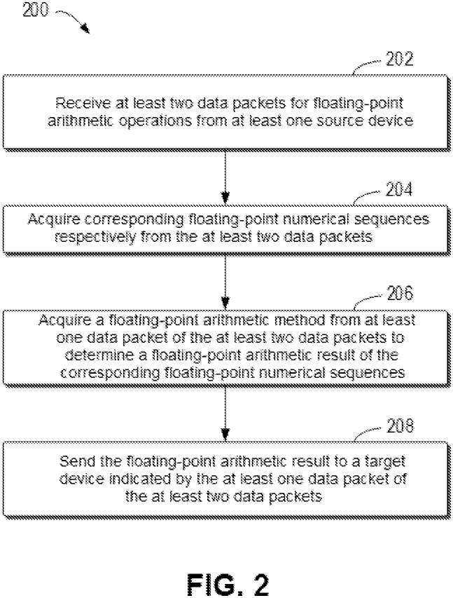

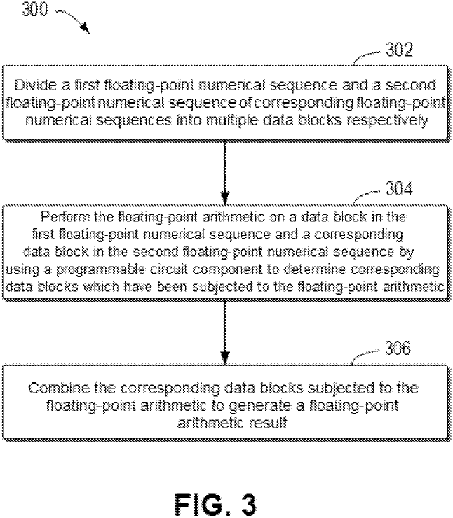

A process according to an embodiment of the present disclosure will be described in detail below with reference to FIGS. 2 and 3. For ease of understanding, the specific data mentioned in the following description are all illustrative and are not intended to limit the scope of protection of the present disclosure. It should be understood that the embodiment described below may also include additional actions not shown and/or may omit actions shown, and the scope of the present disclosure is not limited in this regard.

FIG. 2 is a flowchart of process 200 of implementing data processing at an edge switch according to an embodiment of the present disclosure. In some embodiments, process 200 may be implemented by computing device 130 in FIG. 1. Process 200 for data processing according to an embodiment of the present disclosure is now described with reference to FIG. 1. For ease of understanding, specific examples mentioned in the following description are all illustrative and are not used to limit the protection scope of the present disclosure.

As shown in FIG. 2, at 202, computing device 130 may receive at least two data packets for floating-point arithmetic operations from at least one source device. As an example, the at least one source device may be IoT device 110 shown in FIG. 1. As another example, the at least one source device may be two or more IoT devices, and each of the IoT devices sends data packets for floating-point arithmetic operations to computing device 130 in edge switch 120.

In some embodiments, to determine whether computing device 130 in edge switch 120 has a floating-point arithmetic function, IoT device 110 may send a floating-point arithmetic service request message to edge switch 120. After computing device 130 determines that the floating-point arithmetic service request message is received from IoT device 110, computing device 130 may send a floating-point arithmetic service response message to IoT device 110, so as to inform IoT device 110 that edge switch 120 can provide floating-point arithmetic services. In this way, it can be avoided that IoT device 110 directly sends the data packet used for the floating-point arithmetic operation to the edge switch that does not have the floating-point arithmetic function.

Subsequently, at 204, computing device 130 may acquire corresponding floating-point numerical sequences respectively from the at least two data packets. As an example, the at least two data packets are a first data packet, a second data packet, and a third data packet. Therefore, computing device 130 may acquire floating-point numerical sequences used for the floating-point arithmetic respectively from the first data packet, the second data packet, and the third data packet, such as a first floating-point numerical sequence [A, B, C, D, E, F, G, H], a second floating-point numerical sequence [a, b, c, d, e, f, g, h], and a third floating-point numerical sequence [1, 2, 3, 4, 5, 6, 7, 8]. A, B, C, D, E, F, G, H, a, b, c, d, e, f, g, and h are floating-point numerical values.

At 206, computing device 130 may acquire a floating-point arithmetic method from at least one data packet of the at least two data packets to determine a floating-point arithmetic result of the corresponding floating-point numerical sequences. As an example, the floating-point arithmetic method may be used to indicate whether the floating-point arithmetic is floating-point addition arithmetic or floating-point subtraction arithmetic. For example, when it is determined that the floating-point arithmetic method is floating-point addition arithmetic, computing device 130 may sum the first floating-point numerical sequence [A, B, C, D, E, F, G, H], the second floating-point numerical sequence [a, b, c, d, e, f, g, h], and the third floating-point numerical sequence [1, 2, 3, 4, 5, 6, 7, 8] to determine the floating-point arithmetic result [A+a+1, B+b+2, C+c+3, D+d+4, E+e+5, F+f+6, G+g+7, H+h+8].

In some embodiments, in order to save computing resources of computing device 130 such as a CPU in edge switch 120, computing device 130 may also perform floating-point arithmetic on corresponding floating-point numerical sequences by using a programmable circuit component arranged in edge switch 120. FIG. 3 is a flowchart of process 300 of processing floating-point numerical sequences by using a programmable circuit component arranged in an edge switch according to an embodiment of the present disclosure. In some embodiments, process 300 may be executed on computing device 130 in FIG. 1. Process 300 of processing floating-point numerical sequences by using a programmable circuit component arranged in an edge switch according to an embodiment of the present disclosure is described with reference to FIG. 1. For ease of understanding, specific examples mentioned in the following description are all illustrative and are not used to limit the protection scope of the present disclosure.

As shown in FIG. 3, at 302, computing device 130 may divide a first floating-point numerical sequence and a second floating-point numerical sequence of the corresponding floating-point numerical sequences into multiple data blocks respectively. As an example, computing device 130 may divide a data packet into eight data blocks, and each of the data blocks has a specific order and number.

At 304, computing device 130 may perform the floating-point arithmetic on a data block in the first floating-point numerical sequence and a corresponding data block in the second floating-point numerical sequence by using the programmable circuit component to determine a corresponding data block which has been subjected to the floating-point arithmetic. As an example, the programmable circuit component may be a programmable switch chip.

At 306, computing device 130 may combine the corresponding data blocks which have been subjected to the floating-point arithmetic to generate a floating-point arithmetic result. In some embodiments, the data packet used for the floating-point arithmetic may be divided into multiple data blocks, and computing device 130 may perform floating-point arithmetic operations sequentially on these data blocks. Whenever a floating-point arithmetic operation is performed on a data block, the data block which has been subjected to the floating-point arithmetic may be stored in a register arranged in edge switch 120. Moreover, after all data blocks of the data packet have undergone floating-point arithmetic, all data blocks stored in the register can be combined into a floating-point arithmetic result. In this way, the floating-point arithmetic can be performed on each data block one by one in a pipelined manner, so as to enable the programmable circuit component such as the programmable switch chip to complete a floating-point arithmetic task of the data packet.

As an example, when the programmable switch chip receives an ingress data packet, floating-point arithmetic processing will be performed on a first data block in an ingress session. A floating-point arithmetic result of the data block may be stored in the register. Subsequently, the programmable switch chip will pop the first data block in an exit session and re-distribute other data blocks. For example, in the ingress session, the second data block may be processed with the same logic. After all the data blocks are processed, results stored in the register will be pushed back to the empty data packet and combined into the floating-point arithmetic result.

Then, referring back to FIG. 2, at 208, computing device 130 may send the floating-point arithmetic result to a target device indicated by the at least one data packet of the at least two data packets. As an example, the target device may be computing node 150 in FIG. 1. It should be understood that the data packet may include floating-point numerical sequences for the floating-point arithmetic as well as location information (such as an IP address) of the target device. As another example, when IoT device 110 needs to perform the floating-point arithmetic on the data acquired by itself, computing device 130 may return the floating-point arithmetic result to IoT device 110. As a further example, when computing node 150 is configured to collect monitoring data of multiple IoT devices, computing device 130 may send the floating-point arithmetic result to computing node 150.

In some embodiments, edge switch 120 is configured so as to be adjacent to IoT device 110.

In some embodiments, computing node 150 as the target device is configured to perform model training. For example, IoT device 110 or multiple IoT devices may send precise floating-point numerical values to edge switch 120 so that edge switch 120 can use a programmable circuit therein to sum the floating-point numerical sequences. Hence, edge switch 120 may directly send a calculation result of the floating-point sum operation to computing node 150 via cloud 140. After collecting a sufficient amount of field data, computing node 150 may train a corresponding machine learning or deep learning model. Correspondingly, in a model application stage, IoT device 110 may also send floating-point numerical values collected in real time to edge switch 120 for relevant floating-point arithmetic, and edge switch 120 sends a calculation result to computing node 150 via cloud 140. Computing node 150 may generate a control signal based on the calculation result by using the trained model, and send the control signal to IoT device 110 via cloud 140 and edge switch 120, so as to adjust relevant functions of IoT device 110.

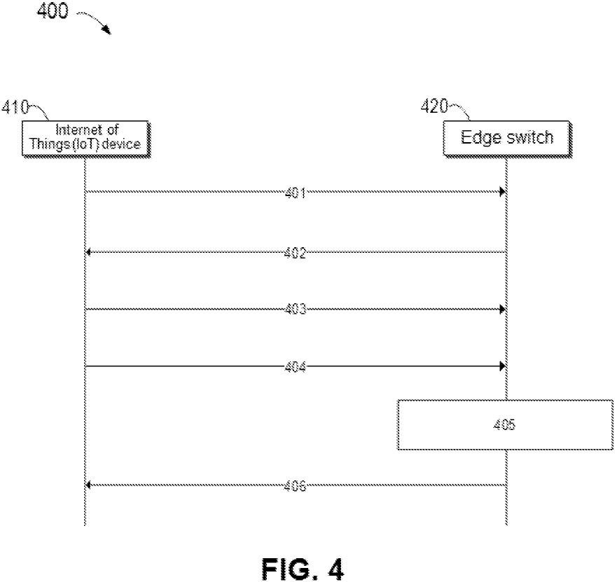

In order to more clearly present example ideas of the present disclosure, FIG. 4 is a signaling diagram of process 400 of implementing data processing at an edge switch according to an embodiment of the present disclosure.

As shown in FIG. 4, when IoT device 410 needs to perform floating-point arithmetic, in order to determine whether edge switch 420 has a function of floating-point arithmetic service, IoT device 410 may first send 401 a floating-point arithmetic service request to edge switch 420 arranged nearby. When edge switch 420 receives a floating-point arithmetic service request message from IoT device 410, edge switch 420 may send 402 a floating-point arithmetic service response to IoT device 410. In this way, IoT device 410 may know that edge switch 420 can provide floating-point arithmetic services. In this way, it can be avoided that IoT device 410 directly sends a data packet used for the floating-point arithmetic to an edge switch that does not have the floating-point arithmetic function.

After it is determined that edge switch 420 has a function of performing the floating-point arithmetic on the data packet, IoT device 410 may further send 403 an enable signal to edge switch 420, so that edge switch 420 can perform an initialization operation of the floating-point arithmetic. Subsequently, IoT device 410 may send 404 floating-point numerical sequences requiring the floating-point arithmetic to edge switch 420.

After receiving the floating-point numerical sequences, edge switch 420 may create an event (or a task) for performing 405 floating-point arithmetic on the floating-point numerical sequences. As an example, edge switch 420 may use an internal programmable switch chip to perform floating-point arithmetic operations. In order to enable the programmable switch chip to process large data packets, the data packet can be divided into multiple data blocks, and floating-point arithmetic operations can be performed on each data block in turn. Subsequently, edge switch 420 may send 406 a floating-point arithmetic result to IoT device 410. It should be understood that the floating-point arithmetic result may also be transmitted to any designated computing node.

By means of the above embodiments, the solution of performing floating-point arithmetic at an edge switch of the present disclosure can reduce the computing load of an IoT device, a cloud, and a server while ensuring the floating-point arithmetic performance, and can also reduce a time delay generated due to floating-point arithmetic operations. A floating-point arithmetic architecture of the present disclosure can establish a transit between the IoT device and the server that undertakes floating-point arithmetic tasks with short delay, and the transit is an edge switch existing in a communication system. In addition, by means of a programmable edge switch, computation tasks of the floating-point arithmetic can be shifted from the IoT device to the programmable edge switch, so that the IoT device can achieve better performance, higher throughput, and lower latency for secure data transmission.

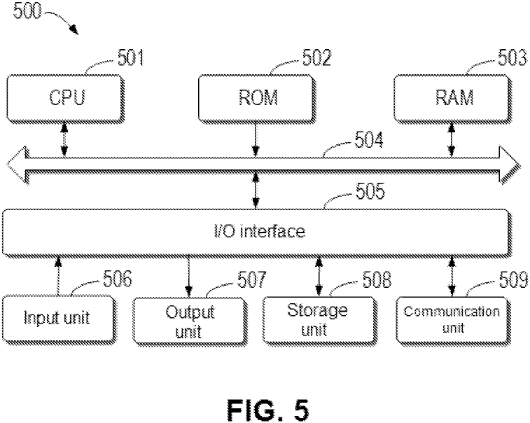

FIG. 5 is a schematic block diagram of example electronic device 500 that can be used to implement embodiments of the present disclosure. For example, electronic device 500 can be used to implement computing device 130 shown in FIG. 1. As shown in the figure, electronic device 500 includes central processing unit (CPU) 501 that may perform various appropriate actions and processing according to computer program instructions stored in read-only memory (ROM) 502 or computer program instructions loaded from storage unit 508 to random access memory (RAM) 503. Various programs and data required for operations of device 500 may also be stored in RAM 503. CPU 501, ROM 502, and RAM 503 are connected to each other through bus 504. Input/output (I/O) interface 505 is also connected to bus 504.

A plurality of components in device 500 are connected to I/O interface 505, including: input unit 506, such as a keyboard and a mouse; output unit 507, such as various types of displays and speakers; storage unit 508, such as a magnetic disk and an optical disc; and communication unit 509, such as a network card, a modem, and a wireless communication transceiver. Communication unit 509 allows device 500 to exchange information/data with other devices via a computer network, such as the Internet, and/or various telecommunication networks.

CPU 501 performs the various methods and processing described above, such as process 200 and process 300. For example, in some embodiments, the various methods and processing described above may be implemented as a computer software program or a computer program product, which is tangibly included in a machine-readable medium, such as storage unit 508. In some embodiments, part of or all the computer program may be loaded and/or installed to device 500 via ROM 502 and/or communication unit 509. When the computer program is loaded into RAM 503 and executed by CPU 501, one or more steps of any process described above may be implemented. Alternatively, in other embodiments, CPU 501 may be configured in any other suitable manner (for example, by means of firmware) to perform a process such as process 200 and process 300.

Example embodiments of the present disclosure include a method, an apparatus, a system, and/or a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electrical storage device, a magnetic storage device, an optical storage device, an electromagnetic storage device, a semiconductor storage device, any non-transitory storage device, or any appropriate combination of the above. More specific examples (a non-exhaustive list) of the computer-readable storage medium include: a portable computer disk, a hard disk, a RAM, a ROM, an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in the computing/processing device.

The computer program instructions for executing the operation of the present disclosure may be assembly instructions, instruction set architecture (ISA) instructions, machine instructions, machine-dependent instructions, microcode, firmware instructions, status setting data, or source code or object code written in any combination of one or more programming languages, the programming languages including object-oriented programming languages such as Smalltalk and C++, and conventional procedural programming languages such as the C language or similar programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer may be connected to a user computer through any kind of networks, including a local area network (LAN) or a wide area network (WAN), or may be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions to implement various aspects of the present disclosure.

Various aspects of the present disclosure are described herein with reference to flowcharts and/or block diagrams of the method, the apparatus (system), and the computer program product according to embodiments of the present disclosure. It should be understood that each block of the flowcharts and/or the block diagrams and combinations of blocks in the flowcharts and/or the block diagrams may be implemented by computer-readable program instructions.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or more blocks in the flowcharts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or more blocks in the flowcharts and/or block diagrams.

The computer-readable program instructions may also be loaded to a computer, a further programmable data processing apparatus, or a further device, so that a series of operating steps may be performed on the computer, the further programmable data processing apparatus, or the further device to produce a computer-implemented process, such that the instructions executed on the computer, the further programmable data processing apparatus, or the further device may implement the functions/actions specified in one or more blocks in the flowcharts and/or block diagrams.

The flowcharts and block diagrams in the drawings illustrate the architectures, functions, and operations of possible implementations of the systems, methods, and computer program products according to various embodiments of the present disclosure. In this regard, each block in the flowcharts or block diagrams may represent a module, a program segment, or part of an instruction, the module, program segment, or part of an instruction including one or more executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in a reverse order, which depends on involved functions. It should be further noted that each block in the block diagrams and/or flowcharts as well as a combination of blocks in the block diagrams and/or flowcharts may be implemented by using a special hardware-based system that executes specified functions or actions, or implemented by using a combination of special hardware and computer instructions.

Various implementations of the present disclosure have been described above. The foregoing description is illustrative rather than exhaustive, and is not limited to the disclosed implementations. Numerous modifications and alterations will be apparent to persons of ordinary skill in the art without departing from the scope and spirit of the illustrated implementations. The selection of terms used herein is intended to best explain the principles and practical applications of the implementations or the improvements to technologies on the market, so as to enable persons of ordinary skill in the art to understand the implementations disclosed herein.

What is claimed is:

1. A data processing method implemented at an edge switch, comprising:
receiving at least two data packets for floating-point arithmetic operations from at least one source device;
acquiring corresponding floating-point numerical sequences respectively from the at least two data packets;
acquiring a floating-point arithmetic method from at least one data packet of the at least two data packets to determine a floating-point arithmetic result of the corresponding floating-point numerical sequences; and
sending the floating-point arithmetic result to a target device indicated by the at least one data packet of the at least two data packets.

2. The method according to claim 1, wherein the floating-point arithmetic method comprises floating-point addition arithmetic or floating-point subtraction arithmetic.

3. The method according to claim 1, wherein determining the floating-point arithmetic result comprises:
performing floating-point arithmetic on the corresponding floating-point numerical sequences by using a programmable circuit component in the edge switch.

4. The method according to claim 3, wherein performing floating-point arithmetic on the corresponding floating-point numerical sequences by using the programmable circuit component comprises:
dividing a first floating-point numerical sequence and a second floating-point numerical sequence of the corresponding floating-point numerical sequences into multiple data blocks respectively;
performing the floating-point arithmetic on a data block in the first floating-point numerical sequence and a corresponding data block in the second floating-point numerical sequence by using the programmable circuit component to determine corresponding data blocks which have been subjected to the floating-point arithmetic; and
combining the corresponding data blocks which have been subjected to the floating-point arithmetic to generate the floating-point arithmetic result.

5. The method according to claim 1, further comprising:
sending a floating-point arithmetic service response message to the at least one source device in response to receiving a floating-point arithmetic service request message from the at least one source device to inform the at least one source device that the edge switch can provide floating-point arithmetic services.

6. The method according to claim 1, wherein the at least one source device comprises an IoT device, the edge switch comprises a programmable switch, and the edge switch is configured so as to be adjacent to the IoT device.

7. The method according to claim 1, wherein the target device comprises a computing node configured to perform model training.

8. An electronic device, comprising:
a processor; and
a memory coupled to the processor and having instructions stored therein which, when executed by the processor, cause the electronic device to perform actions at an edge switch, the actions comprising:
receiving at least two data packets for floating-point arithmetic operations from at least one source device;
acquiring corresponding floating-point numerical sequences respectively from the at least two data packets;
acquiring a floating-point arithmetic method from at least one data packet of the at least two data packets to determine a floating-point arithmetic result of the corresponding floating-point numerical sequences; and
sending the floating-point arithmetic result to a target device indicated by the at least one data packet of the at least two data packets.

9. The device according to claim 8, wherein the floating-point arithmetic method comprises floating-point addition arithmetic or floating-point subtraction arithmetic.

10. The device according to claim 8, wherein determining the floating-point arithmetic result comprises:
performing floating-point arithmetic on the corresponding floating-point numerical sequences by using a programmable circuit component in the edge switch.

11. The device according to claim 10, wherein performing floating-point arithmetic on the corresponding floating-point numerical sequences by using the programmable circuit component comprises:
dividing a first floating-point numerical sequence and a second floating-point numerical sequence of the corresponding floating-point numerical sequences into multiple data blocks respectively;
performing the floating-point arithmetic on a data block in the first floating-point numerical sequence and a corresponding data block in the second floating-point numerical sequence by using the programmable circuit component to determine corresponding data blocks which have been subjected to the floating-point arithmetic; and
combining the corresponding data blocks which have been subjected to the floating-point arithmetic to generate the floating-point arithmetic result.

12. The device according to claim 8, wherein the actions further comprise:
sending a floating-point arithmetic service response message to the at least one source device in response to receiving a floating-point arithmetic service request message from the at least one source device to inform the at least one source device that the edge switch can provide floating-point arithmetic services.

13. The device according to claim 8, wherein the at least one source device comprises an IoT device, the edge switch comprises a programmable switch, and the edge switch is configured so as to be adjacent to the IoT device.

14. The device according to claim 8, wherein the target device comprises a computing node configured to perform model training.

15. A computer program product that is tangibly stored on a non-transitory computer-readable medium and comprises machine-executable instructions which, when executed by a machine, cause the machine to execute a data processing method implemented at an edge switch, the method comprising:
receiving at least two data packets for floating-point arithmetic operations from at least one source device;
acquiring corresponding floating-point numerical sequences respectively from the at least two data packets;
acquiring a floating-point arithmetic method from at least one data packet of the at least two data packets to determine a floating-point arithmetic result of the corresponding floating-point numerical sequences; and
sending the floating-point arithmetic result to a target device indicated by the at least one data packet of the at least two data packets.

16. The computer program product according to claim 15, wherein the floating-point arithmetic method comprises floating-point addition arithmetic or floating-point subtraction arithmetic.

17. The computer program product according to claim 15, wherein determining the floating-point arithmetic result comprises:
performing floating-point arithmetic on the corresponding floating-point numerical sequences by using a programmable circuit component in the edge switch.

18. The computer program product according to claim 17, wherein performing floating-point arithmetic on the corresponding floating-point numerical sequences by using the programmable circuit component comprises:
dividing a first floating-point numerical sequence and a second floating-point numerical sequence of the corresponding floating-point numerical sequences into multiple data blocks respectively;
performing the floating-point arithmetic on a data block in the first floating-point numerical sequence and a corresponding data block in the second floating-point numerical sequence by using the programmable circuit component to determine corresponding data blocks which have been subjected to the floating-point arithmetic; and
combining the corresponding data blocks which have been subjected to the floating-point arithmetic to generate the floating-point arithmetic result.

19. The computer program product according to claim 15, further comprising:
sending a floating-point arithmetic service response message to the at least one source device in response to receiving a floating-point arithmetic service request message from the at least one source device to inform the at least one source device that the edge switch can provide floating-point arithmetic services.

20. The computer program product according to claim 15, wherein the at least one source device comprises an IoT device, the edge switch comprises a programmable switch, and the edge switch is configured so as to be adjacent to the IoT device.
